(19) United States
(12) Patent Application Publication
(10) Pub. No.: US 2007/0277238 A1
(43) Pub. Date: Nov. 29, 2007

(54) Method And System For Preventing Exploitation Of Email Messages

(75) Inventors: Yanki Margalit, Ramat-Gan (IL); Dany Margalit, Ramat-Gan (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: ALADDIN KNOWLEDGE SYSTEMS LTD., Tel Aviv (IL)

(21) Appl. No.: 11/740,297

(22) Filed: Apr. 26, 2007

Related U.S. Application Data
(63) Continuation-in-part of application No. 10/681,904, filed on Oct. 10, 2003, now abandoned.

(51) Int. Cl. G06F 15/16

(52) U.S. Cl. 726/22

(57) ABSTRACT

A method and system for preventing the exploitation of email messages in attacks on computer systems. Invalid formatting is often used by attackers to introduce undesirable content into email, because email handling applications and utilities are often insensitive to deviations from the standards, and invalid formatting can allow undesirable content to go undetected. According to the present invention, an original email message is decomposed into component parts, which are formatted according to email message standards. Format-compliant components are inspected for undesirable content and reassembled into a replacement email message that is sent to the destination of the original email message. Components with undesirable content are sanitized.

This is a continuation-in-part of U.S. patent application Ser. No. 10/681,904 filed Oct. 10, 2003.

### FIELD OF THE INVENTION

The present invention relates to the field of preventing computer attacks carried out via email messages.

### BACKGROUND OF THE INVENTION

There are currently many security systems for inspecting email messages for malicious content, and for sanitizing or blocking email messages which have been found to contain security threats or other undesirable material, such as pornography or unwanted email (generally denoted as “spam” or “junk” messages). One of the problems confronting such security systems, however, is that there are no standards for the interpretation of email messages—the current standards are applicable only to the construction of email messages and do not specify how to interpret email messages which have been constructed in ways which deviate from the standards. Thus, software applications which read or otherwise process email messages necessarily employ different approaches to interpreting those email messages.

This fact is exploited by attackers to introduce malicious or other undesirable material into email messages. An attacker may construct an email message which intentionally deviates from the standards with the goal of confusing security systems into considering that the email message is safe. The attacker relies on the fact that the security system might interpret the email message using an approach in which the email message appears harmless, whereas software in the recipient's computer might interpret the email message using a different approach in which the undesirable content of the email message is apparent. In case of malicious content in the email message, the malicious content may be activated to cause damage.

Published Standards

The construction of email messages is specified, for example, in standards including, but not limited to: RFC 2822; and RFC's 2045 through 2049, which are incorporated by reference as if set forth fully herein. The term “standard” herein denotes any of such published material which specifies the composition and/or structure of email messages.

Basic Definitions

The term “message” herein denotes an “email message”, also known as an “electronic mail message”.

The term “content”, in the context of email messages, herein denotes the informational substance in a message or attached thereto, whether encrypted or in clear, whether compressed or uncompressed, and having significance when extracted or separated from, and independent of, the message itself. Content includes, but is not limited to: material having meaning or significance to a human user; numerical data, symbolic data, and logical data; information expressed in language, including natural human languages and formal mathematical languages; text; graphics and images; sound, such as speech, music, and the like; combinations of the foregoing, such as multi-media, and the like; operational instructions to a computer or other processing device for carrying out data-manipulating procedures, such as executable code, pseudo-code, and data processing statements in programs, applications, applets, scripts, macros, and the like; and computer files. Content is considered as such whether in so-called “attachments” to a message or within the so-called “body” of a message.

The term “envelope”, in the context of email messages, herein denotes data and meta-data relating to a message itself, for the purposes of accomplishing transmission, delivery, and tracking of the message, and includes, but is not limited to: network address information of the sender and/or recipient; time-stamp data of the message; originating application of the message; priority of the message; status of the message; standard and version of the message construction; message identifiers; and network routing information thereof.

The term “component”, in the context of email messages, herein denotes a portion of a message which is capable of being individually composed, identified, extracted, separated, considered, or analyzed according to one or more standards. A component may have “subcomponents”, which are also considered to be components in the context of the present invention.

The term “undesirable content” herein denotes any content which has been specified as unwanted, and for which there exist current prior-art detection and handling methods. Undesirable content includes, but is not limited to: malicious content (see below); unwanted or unsolicited email messages (generally denoted by terms such as “spam” and “junk email”); pornographic or other offensive material, language, or graphic content; fraudulent offers, enticements, and similar scams; and combinations of the above.

The term “malicious content” herein denotes any content that poses a threat or a potential threat to the security of a computer system or network, including, but not limited to: a computer virus; a network worm; computer code commonly designated as “spyware”, “malware”, and the like; executable computer code which is intended to carry out a security attack on a host computer, with or without damage to files, programs, or data.

The term “sanitizing” herein denotes the processing of undesirable content, an email message, or a component thereof to eliminate the effect of the undesirable content, and thereby render the email message or component, or the remainder thereof, effectively devoid of undesirable content. Sanitizing includes, but is not limited to actions on undesirable content, the email message, and/or the email message component, such as; removing; deleting; erasing; overwriting; deactivating, disabling, filtering, blocking, and/or neutralizing of undesirable content from an email message or a component thereof. In a non-limiting example, an email message may be sanitized by removing a component thereof which contains undesirable content. In another non-limiting example, a sanitizing operation may remove an entire email message which contains undesirable content.

Format and Formatting

The terms “format”, “formatting”, and variants thereof, in the context of email messages, herein denote one or more specifications, schemes, plans, conventions, customs, and/or standards for the organization, arrangement, ordering, sequencing, positioning, delimiting, grouping, and/or presentation of the data that constitutes content and/or envelope as defined above.

Formatting includes, but is not limited to, such specifications, etc., for:
ordering and/or layout of data;
display and/or appearance of data;
data encoding;
segmentation of content and/or envelope;
permissible ranges for the size of the content and/or envelope data representations;
permissible ranges for data encoding values;
numerical representations of symbols used to convey content and/or envelope information;
headers, terminators, delimiters, separators, and the like, for different portions of content and/or envelope data; and
meta-data relating to content and/or envelope.

The published standards mentioned above specify standard formats for email messages at various different levels, including the component level. The term “construction” in the context of creating an email message herein denotes a process of formatting as defined in this section. Thus, the terms “format”, “formatting”, etc., furthermore herein encompass syntactic and semantic considerations related to the envelope, packaging of the message contents, and/or construction of email messages, as specified by one or more standards.

It is noted and emphasized that formatting is typically applied independently and simultaneously at various levels, including, but not limited to:
the character level;
the line level;
the component level; and
the envelope level.

Accordingly, the terms “format”, “formatting”, etc., as used herein apply without limitation to all such levels.

Format and content are typically independent of one another and mutually-exclusive of one another, in that a feature which is considered content (as herein defined) cannot simultaneously be considered as formatting (as herein defined), and vice versa. Distinctions include, but are not limited to the following:
formatting can be applied to content regardless of the specific information thereof;
content can typically be converted from one format to another without substantially affecting the information of the content;
content has informational value separate from the message, and can be separated therefrom; whereas
formatting carries no message information and cannot be meaningfully separated from the message.

In addition, many format conversions are reversible, where the meta-data of the original format is preserved in the converted format. In such cases, it is possible to covert content from a first format to a second format, and subsequently from the second format back to the first format, in a process referred to as “round-tripping”. Round-tripping is typically performed in cases where the content needs to be in the first format for compatibility reasons, but where a desired data processing operation on the content is more easily carried out when the content is in the second format.

With respect to the above distinctions between formatting and content, it is noted that according to the definitions herein, the permissible ranges for data encoding and the numerical representations of symbols used to convey content information are part of the formatting of an email message. Thus, the inclusion of invalid characters or symbols in an email message is herein considered to be invalid formatting, rather than invalid content. As a non-limiting example: a specification that the permissible symbol set in a particular message component is the non-NULL ASCII character set (having values 1 through 127) is herein defined as a formatting specification. Thus, in this example, the appearance of a character value FF (hexadecimal) in this message component is considered to be invalid formatting, rather than invalid content. Likewise, permissible ranges for the size of content data representations are considered to be formatting issues, so excessive data included in an email component also constitutes invalid formatting, rather than invalid content.

Non-Limiting Examples of Specific Formatting Categories Related to Email

Formatting in email messages encompasses, but is not limited to, the following, as specified and presented in various standards related thereto, and as referenced above:
character set;
CRLF specifications;
control characters;
7-bit versus 8-bit data;
binary data usage;
structure and length of lines;
structure and organization of header fields of any type, including but not limited to: structured header fields; unstructured header fields; MIME header fields, MIME-Version header fields; MIME extension header fields; content-type header fields; content-transfer-encoding header fields; content-ID header fields; content-description header fields;
structure and organization of other message fields of any type, including, but not limited to: originator fields; destination fields; identification fields; informational fields; resent fields; trace fields; obsolete fields related to any of the preceding fields;
structure and organization of quoted-printable encoding;
structure and organization of Base64 encoding;
padding conventions;
white space conventions;
token conventions, including, but not limited to: lexical tokens; primitive tokens;
timestamp, date, and time format specifications;
network address format specifications;
message syntactical specifications.

FIG. 1 illustrates a simple email message having three components, as defined above: a header 5; a delimiter row 15, which is empty; and message text 10. Header 5 in turn has four sub-components: a sender field 11; a recipient field 12; a subject field 13; and a date field 14. Message text 10 likewise has sub-components: a line of text 16, a line of text 17, and a line of text 18.

It is noted that many applications which handle email do not detect or indicate invalid formatting. As a non-limiting example, it is noted that the standards typically do not specify formatting of the date field (such as date field 14 in FIG. 1), and therefore additional characters added to this field will not be detected by an email client or server as invalid formatting, or as a formatting error.

Email Flexibility and Exploitation for Computer Attacks

As previously noted, despite the existence of standards regarding email formatting, the format of email messages is not rigid, but is actually flexible. In addition, email applications typically try to handle deviations from the standards in order to enable communication between as many email applications as possible. This is necessary in order to accommodate the many formatting variations which came into existence during the development of the email system within the Internet. As noted in the introduction to REC 2047, email-handling programs within the Internet itself are known to be sources of a variety of deviations from the formatting standards. The introduction to RFC 2047 also notes that attempting to eliminate these sources of formatting deviations would cause severe operational problems for the Internet email system. It is therefore to be expected that email formatting will continue to exhibit considerable deviation from the published standards.

Exploitation of Email Message Format Variations

As also previously noted, the relatively free format of email and the manner in which applications process email is exploited by attackers for introducing hostile material into recipients' computers, mail servers and inspection facilities (e.g., systems for detecting hostile material within email messages) operating between senders and recipients.

To re-emphasize the nature of the problem, the lack of standards in formatting of email messages and the variety of possible ways of interpreting non-standard email formats means that malicious or other undesirable content in an email message deviating from the published formatting standards may not be recognized by a security inspection program which uses a particular approach for interpreting email. This message would then be delivered to a recipient whose software may interpret the non-standard format in a different manner that causes the undesirable content to be delivered, including the activation of malicious content to cause damage. This vulnerability is exploited by attackers to introduce potentially-destructive or other undesirable content into email messages so that the undesirable content may evade detection.

The terms “exploit”, “exploitation”, and variants thereof, herein refer to an attack on a computer system that takes advantage of a particular vulnerability of the computer, the computer operating system, or an application running on the computer.

In a non-limiting example, lack of protection against memory buffer overflow is a known vulnerability in a variety of applications. To exploit this vulnerability, an attacker prepares and formats data in such a manner as to cause a memory buffer overflow from the application to overlay data in a memory area reserved for executable code. By placing malicious executable computer code in the overflow data, the attacker thereby gains control over the system when that malicious code is executed after overflowing the buffer into the executable code area.

FIG. 2 schematically illustrates a buffer overflow attack. A computer memory 20 holds an email-client software application 21 having an input data buffer area 25, and an executable code area 23. An incoming email message 22 is read into buffer area 25. The attacker, however, has used an invalid format for email message 22, so that email message 22 will overflow buffer area 25 on input. This causes a portion of email message 22 to exceed the memory allocated for buffer 25 and thereby overwrite memory area 23, reserved for executable code. This is illustrated by an arrow 24, which symbolizes the overflow of buffer 25 containing data from email message 22. The malicious code which the attacker has included in email message 22 is therefore written into an area which is executed, thereby allowing the attacker to gain control of the computer and cause damage.

Another well-known vulnerability of email-related systems is that an inspection facility may not be familiar with a certain structure of email message and consequently allows an attachment to reach the recipient's system (“proprietary encoding type”). This may be exploited for introducing hostile content into the recipient's machine and mail server. For example, Base64 and TNEF (Transport Neutral Encapsulation Format) are formats for files attached to an email message. Some email inspection facilities, however, do not support TNEF. Thus, if an email message sent by Microsoft Outlook uses the TNEF format an inspection facility that does not support TNEF will not look for hostile content within the attachment and consequently the recipient may receive an un-inspected file. Furthermore, email clients that do not support a certain attachment format do not let their users use an attached file in this format.

FIG. 3 illustrates an email message 30 generated by the Outlook Express email client. A file named FIG00009. BMP is attached to the message. The file is in Base64 format, having rows 32 of 76 characters each, except for possibly the final row (not shown). Email message 30 has a single text row 34, and is a multi-component message, wherein each component is delimited by a boundary row, such as a boundary row 31a and a boundary row 31b. The name of the attached file appears twice, in a line 33a and in a line 33b.

This example highlights and emphasizes the previously-noted deficiency of the standards—although the standards precisely specify the formats to be used in constructing email messages and in some cases specify required format-interpreting capabilities of compliant receivers, the standards typically fail to specify how deviations from the specified formats are to be handled in the case of erroneous or invalid formatting.

The above-referenced deficiency permits exploitation, as suggested by the non-limiting example of FIG. 3, where the name of the attached file appears twice as noted above. It is not specified how an email client must handle the case where these names are not identical. Other unspecified responses include, but are not limited to the following:
It is not specified how a email client should handle a condition where the rows of an attached file are not the same size, or are not of the size specified in the standards.
It is not specified how an inspection facility should handle a condition where an attached file has been given an extension that indicates a different file type from the file's actual type, a condition referred to as “file-type masquerading” (for example, a *.bmp extension indicating an image file, when the attached file is actually an executable file).

With regard to invalid attachments, another well-known vulnerability is that the row length employed by some email clients (e.g. Microsoft Outlook) is a multiple of 4 (e.g. 4, 8, 12, 16, 20, 24, . . . 76 bytes, and so forth). When the actual row length does not comply with this rule, different email clients and applications might interpret the rows differently.

A further vulnerability regarding email messages is that some email clients (e.g. Microsoft Outlook) add non-standard messages fields to email messages. Usually such fields are directed to a recipient email client which is of the same product family as the sender's email client (e.g. the sender and the recipient are both Microsoft Outlook). However, from the sender's point of view, the extra fields may contain information which may not be desirable to send to the recipient.

There is thus a need for, and it would be highly advantageous to have, a method and system for preventing attackers from exploiting email application vulnerabilities by intentionally deviating from the formatting standards. This goal is met by the present invention.

### SUMMARY OF THE INVENTION

It is an objective of the present invention to provide a method and system for preventing the exploitation of email messages whose format has been modified to deviate from the published email formatting standards.

It is a further objective of the present invention to enable an email message to comply with a variety of email client applications and programs.

It is a still further objective of the present invention to prevent sending undesirable material via email messages whose format has been modified to deviate from the published email formatting standards.

The present invention is of a method and system for preventing the exploitation of email messages. Embodiments of the present invention include:
a disassembling an email message into components;
inspecting each component to determine if there is undesirable content therein and handling the component and/or email message accordingly (using one or more regular prior-art inspection and handling methods);
reassembling the components into a replacement email message to replace the original email message, wherein the reassembling is performed strictly according to the published email formatting standards; and
inspecting the entire replacement email message for undesirable content and handling the replacement email message accordingly (using one or more regular prior-art inspection and handling methods).

Therefore, according to the present invention there is provided a method for preventing the exploitation of an original email message having a destination, the method including: (a) decomposing the original email message into the components thereof; (b) for each component of the components thereof: (c) formatting the component according to at least one published standards for formatting email into a correctly-formatted email component; (d) inspecting the correctly-formatted email component for undesirable content; (e) if the correctly-formatted email component contains undesirable content, then sanitizing the correctly-formatted email component; (f) reassembling the correctly-formatted email component into a replacement email message; and (g) substituting the replacement email message for the original email message, and sending the replacement email message to the destination of the original email message in place thereof.

In addition, according to the present invention there is provided a method for preventing the exploitation of an original email message having a destination, the method including: (a) decomposing the original email message into the components thereof; (b) for each component of the components thereof: (c) formatting the component according to at least one published standards for formatting email into a correctly-formatted email component; (d) reassembling the correctly-formatted email component into a replacement email message; (e) substituting the replacement email message for the original email message; (f) inspecting the replacement email message for undesirable content; (g) if the replacement email message contains undesirable content, then sanitizing the replacement email message; and (h) sending the replacement email message to the destination of the original email message in place thereof.

Furthermore, according to the present invention there is provided a system for preventing the exploitation of an original email message having a destination, the system including: (a) an email component extractor, for extracting a component of the original email message; (b) an email component standards-compliant formatter, for formatting the component according to at least one published standard; (c) an undesirable content handler operative to inspect for undesirable content and to sanitize at least one of: (d) an email message component; (e) an email message; and (f) an email assembler, for assembling the component into a replacement email message for sending to the destination of original email message in place thereof.

### BRIEF DESCRIPTION OF THE DRAWINGS

The invention is herein described, by way of example only, with reference to the accompanying drawings, wherein:

FIG. 1 illustrates a simple email message.

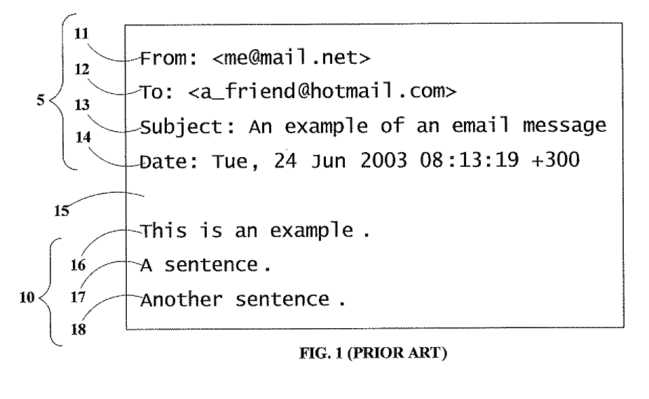

FIG. 2 schematically illustrates a buffer overflow attack.

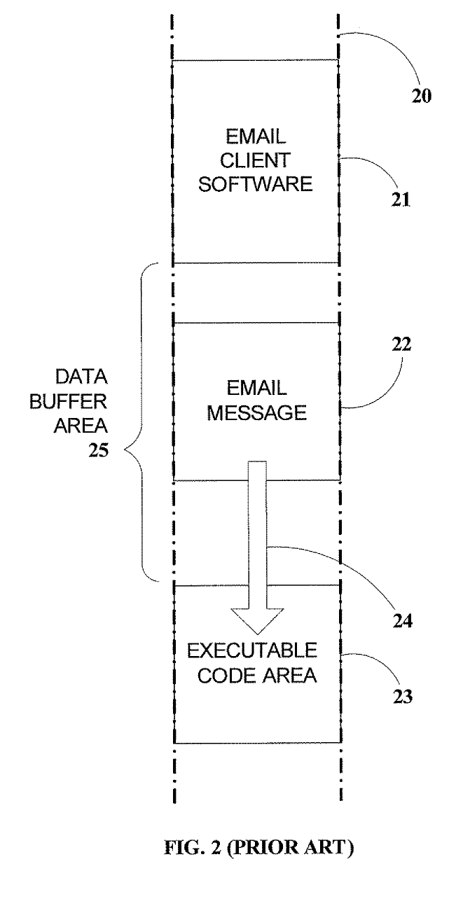

FIG. 3 illustrates the components of an email message generated by an email client.

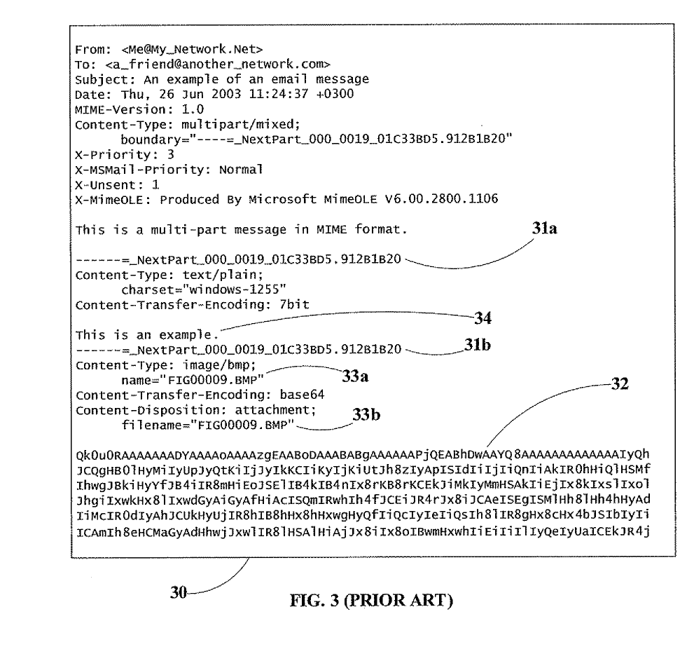

FIG. 4A is a flowchart of a method according to an embodiment of the present invention for preventing the exploitation of an email message.

FIG. 4B is a flowchart of a method according to an alternative embodiment of the present invention for preventing the exploitation of an email message.

FIG. 5 is a conceptual block diagram of a system according to an embodiment of the present invention for preventing the exploitation of email messages.

FIG. 6 schematically illustrates the layout of a mail system according to an embodiment of the present invention for preventing the exploitation of email messages.

### DESCRIPTION OF THE PREFERRED EMBODIMENTS

The principles and operation of methods and systems according to the present invention may be understood with reference to the drawings and the accompanying description.

It is again emphasized that formatting, as discussed in relation to the present invention and embodiments thereof, is that which pertains to email messages, as defined and exemplified previously herein.

Method for Preventing the Exploitation of Email Messages

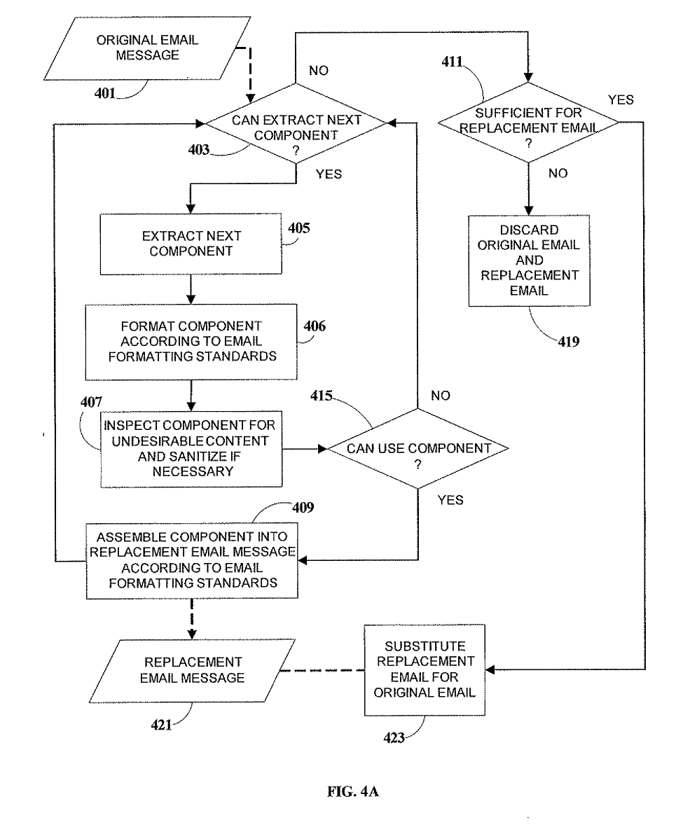

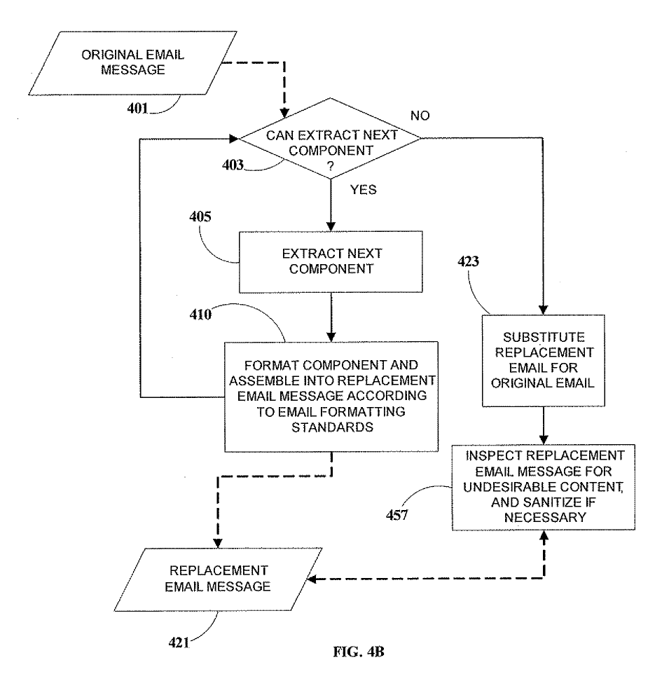

FIG. 4A is a flowchart of a method for preventing the exploitation of a received original email message 401, according to an embodiment of the present invention. According to this embodiment, an original email message 401 is to be replaced by a replacement email message 421, which is intended to be substantially or completely identical to original email message 401, but which in practice may not be identical to original email message 401. Invalid formatting of original email message 401 (i.e., formatting which deviates from the published standards for formatting email messages) which could be used to exploit vulnerabilities in email applications or other software, is corrected, and the email message is sanitized by the method illustrated in FIG. 4A and described herein.

After email message 401 is available, a decision point 403 determines if the next component can be extracted (at the start of the method, the next component is the first component). If the next component is available, a step 405 extracts the next component, after which a formatting step 406 formats the component in accordance with the published email formatting standards into a correctly-formatted component. Then an inspection/handling step 407 inspects the correctly-formatted component for undesirable content, and sanitizes the component if the inspection determines that there is undesirable content in the component. Inspection and handling (sanitizing) are done by one or more suitable prior-art methods and/or systems, as are currently both numerous and well-known by persons familiar with the art. In a non-limiting example, a prior-art anti-virus system and a prior-art anti-spam system are used to inspect and sanitize the component both for viruses and for spam.

At a decision point 415, it is determined whether or not the component can be used in replacement email message 421. In a non-limiting example, it may have been determined in step 407 that the component contains no undesirable content, in which case the component can be used in replacement email message 421. In another non-limiting example, it may have been determined in step 407 that the component contains malicious code, and the sanitizing operation in step 407 may have removed the entire component, in which case, the component cannot be used in replacement email message 421. If the component can be used, in a step 409 the component is assembled into a replacement email message 421, after which decision point 403 is repeated for the next component. If the component cannot be used, then decision point 403 is repeated immediately.

When decision point 403 determines that there are no further components to retrieve from original email message 401, a decision point 411 inspects replacement email 421 to determine if there are sufficient components according to the published formatting standards. If decision point 411 determines that there are sufficient components in replacement email 421, then in a step 423 replacement email message 421 is substituted for original email message 401 for sending to the destination of original email message 401 in place of original email message 401.

It is noted that, if original email 401 is properly formatted according to the standards, and if original email 401 contains no undesirable content, then replacement email 421 is identical in all respects to original email 401.

If, however, decision point 411 determines that there are not sufficient components for replacement email 421, then in a non-limiting embodiment of the present invention, at a step 419, both original email message 401 and replacement email message 421 are discarded. In an alternative non-limiting embodiment of the present invention, if it is not possible to construct a validly-formatted email message from original email message 401, replacement email message 421 contains an advisory message to such effect, and is sent to the destination of original email message 401 in place thereof.

FIG. 4B is a flowchart of a method according to an alternative embodiment of the present invention, which has the same effect as the embodiment illustrated in FIG. 4A and described above, but which is carried out in a different fashion. In this embodiment, a formatting/assembling step 410 combines steps 406 and 409 (FIG. 4A). In addition, inspection/sanitizing step 407 (FIG. 4A), which operates on the components of original email message 401, is replaced by an inspection/sanitizing handling step 457, which operates on entire replacement email message 421. As before, step 457 is performed by one or more suitable prior-art methods and/or systems for inspecting/sanitizing email for undesirable content.

Extracting Components of Email Messages

The terms “extract”, “extracting”, and the like, with reference to a component of an email message herein denotes isolating that component from the rest of the email message of which that component is a part, or within which that component is embedded. Isolating can be performed by operations including, but not limited to: logically separating the component, such as by determining the data limits of the component; and physically copying or moving the data from one location in memory to another. In the context of the present invention, an exact data copy of a component is considered equivalent to the original component itself. The terms “decompose”, “decomposing”, “decomposition”, and the like herein denote a process of extracting all the components of an email message, or rendering that email message into isolated components, as discussed above.

Inspecting and Handling Undesirable Content

In an additional embodiment of the present invention, after a component is obtained (as in step 405 of FIGS. 4A and 4B), the component is inspected for undesirable content. As noted, embodiments of the present invention rely on existing prior-art methods and systems for carrying out such actions as inspection and sanitizing. As also noted previously, embodiments of the present invention make it possible for existing prior-art methods and systems to perform these actions in cases where attackers have created or modified email messages to deviate from the established formatting standards, in an attempt to evade the prior-art methods and systems.

System for Preventing the Exploitation of Email Messages

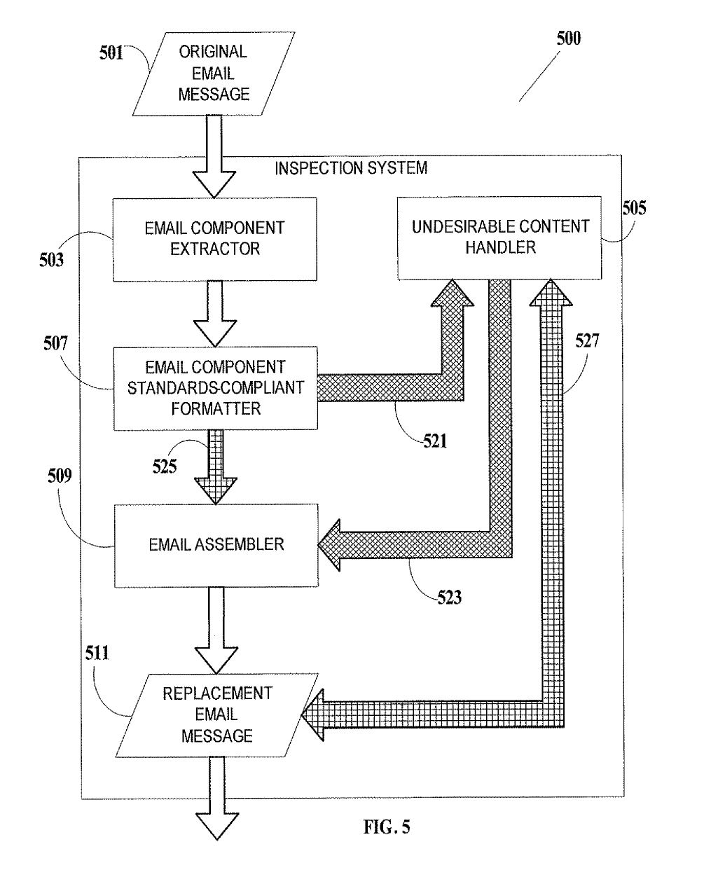

FIG. 5 is a conceptual block diagram of an inspection system 500 according to an embodiment of the present invention for preventing the exploitation of email messages. Inspection system 500 is installed on a suitable hosting platform, such as a server or other processing facility, including, but not limited to: an email client, an add-in to an email client, an email server, and an add-in to an email server.

An original email message 501 is an input to inspection system 500, and is handled by an email component extractor 503, which extracts the components of original email message 501 one at a time and feeds them to an email component standards-compliant formatter 507, which formats an email component strictly according to the published formatting standards.

Inspection system 500 further contains an undesirable content handling unit 505, which is implemented according to one or more prior-art systems, in a manner as previously discussed, for inspecting and sanitizing an email component and/or an email message. Other functional units include; and a email assembler 509, which takes components formatted by formatter 507 and assembles them into a replacement email message 511 according to the published formatting standards.

In an embodiment of the present invention, formatter 507 feeds formatted components via a path 521 to undesirable content handler 505, which processes the components and sends them via a path 523 to email assembler 509.

In an alternative embodiment of the present invention, components from email formatter 507 are input via a path 525 directly to email assembler 509. In this alternative embodiment, undesirable content handler 505 processes replacement email message 511 via a path 527 after assembly by email assembler 509.

For both of the embodiments discussed above, after processing by undesirable content handler 505, replacement email message 511 is ready for delivery to the destination.

A system as presented in FIG. 5 is typically implemented via software on the hosting platform, and can be embodied in a computer program product, as detailed below.

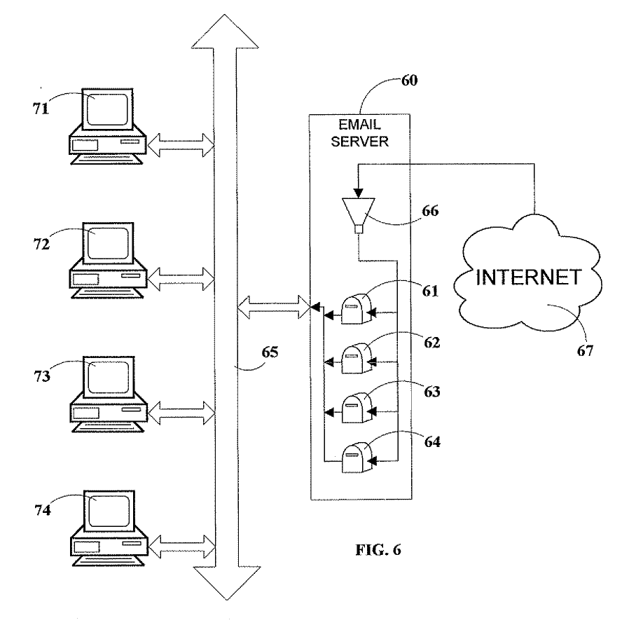

FIG. 6 schematically illustrates the layout of a mail system according to the an embodiment of the present invention for preventing the exploitation of email messages. Users 71 through 74 are connected through a local area network (LAN) 65 to an email server 60. Email server 60 includes email mail boxes 61 through 64, belonging to users 71 through 74, respectively. Email server 60 is connected to the Internet 67, through which users 71 through 74 can exchange email messages with other users worldwide. Users 71 through 74 can also exchange email messages among themselves, in which case the connection to Internet 67 is not involved. The layout described in FIG. 6 features a system 66 for preventing the exploitation of email messages, according to embodiments of the present invention as previously described, notably as shown in FIG. 5, and implementing a method as shown in FIG. 4. System 66 is hosted by email server 60.

Computer Program Product

A further embodiment of the present invention provides a computer program product for performing methods disclosed in the present application or any variants derived therefrom. A computer program product according to this embodiment includes a set of executable commands for a computer, and is incorporated within machine-readable media including, but not limited to: magnetic media; optical media; computer memory; semiconductor memory storage; flash memory storage; and a computer network. The terms “perform”, “performing”, etc., and “run”, “running”, when used with reference to a computer program product herein denote the action of a computer when executing the computer program product, as if the computer program product were performing the actions. The term “computer” herein denotes any data processing apparatus capable of; or configured for, executing the set of executable commands to perform the foregoing method, including, but not limited to: computers; workstations; servers; gateways; routers; switches; networks and network components; processors; firewalls; and controllers.

While the invention has been described with respect to a limited number of embodiments, it will be appreciated that many variations, modifications and other applications of the invention may be made.

1. A method for preventing the exploitation of an original email message having a destination, the method comprising:
decomposing the original email message into the components thereof;
for each component of said components thereof:
formatting said component according to at least one published standards for formatting email into a correctly-formatted email component;
inspecting said correctly-formatted email component for undesirable content;
if said correctly-formatted email component contains undesirable content, then sanitizing said correctly-formatted email component;
reassembling said correctly-formatted email component into a replacement email message; and
substituting said replacement email message for the original email message, and sending said replacement email message to the destination of the original email message in place thereof.

2. The method of claim 1, further comprising:
if said replacement email message has sufficient components according to said at least one published standard, then performing said substituting; and
otherwise discarding the original email message.

3. A computer program product operative to perform the method of claim 1.

4. A computer program product operative to perform the method of claim 2.

5. A method for preventing the exploitation of an original email message having a destination, the method comprising:
decomposing the original email message into the components thereof;
for each component of said components thereof:
formatting said component according to at least one published standards for formatting email into a correctly-formatted email component;
a reassembling said correctly-formatted email component into a replacement email message;
substituting said replacement email message for the original email message;
inspecting said replacement email message for undesirable content;
if said replacement email message contains undesirable content, then sanitizing said replacement email message; and
sending said replacement email message to the destination of the original email message in place thereof.

6. A computer program product operative to perform the method of claim 5.

7. A system for preventing the exploitation of an original email message having a destination, the system comprising:
an email component extractor, for extracting a component of the original email message;
an email component standards-compliant formatter, for formatting said component according to at least one published standard;
an undesirable content handler operative to inspect for undesirable content and to sanitize at least one of:
an email message component;
an email message; and
an email assembler, for assembling said component into a replacement email message for sending to the destination of original email message in place thereof.
